(19) United States
(12) Patent Application Publication
(10) Pub. No.: US 2012/0030765 A1
(43) Pub. Date: Feb. 2, 2012

(54) OPERATION METHOD OF AN ANTI-VIRUS STORAGE DEVICE HAVING A STORAGE DISK AND A READ-ONLY MEMORY

(76) Inventors: Shian-Luen Cheng, Kaohsiung City (TW); Li-Min Lien, Hsinchu County (TW); Tsang-Yi Chen, Taipei County (TW); Chih-Heng Chiu, Taipei City (TW); Chung-Won Shu, Taipei City (TW)

(21) Appl. No.: 12/903,228

(22) Filed: Oct. 13, 2010

(30) Foreign Application Priority Data
Jul. 28, 2010 (TW) 099124890

(51) Int. Cl. G06F 21/00; G06F 12/14

(52) U.S. Cl. 726/24

(57) ABSTRACT

An operation method of an anti-virus storage device having a storage disk and a read-only memory includes connecting the storage device to a host and displaying a single disk name on an interface of an operating system of the host, executing an anti-virus application program corresponding to the operating system, wherein the anti-virus application program is stored in the read-only memory, generating a hidden partition in the storage disk, wherein the hidden partition comprises an anti-virus engine and a virus pattern, and starting up the anti-virus engine, enabling a main storage partition and only displaying a disk name of the main storage partition on the interface of the operating system. If the anti-virus application program has no an execution file corresponding to the operating system, a user using the anti-virus storage device decides whether enables and displays the main storage partition without executing the anti-virus application program.

### BACKGROUND OF THE INVENTION

1. Field of the Invention

The present invention is related to an operation method of an anti-virus storage device, and particularly to an operation method of an anti-virus storage device having a storage disk and a read-only memory.

2. Description of the Prior Art

Please refer to FIG. 1. FIG. 1 is a diagram illustrating an anti-virus storage device 100 according to the prior art. The anti-virus storage device 100 includes a flash 102 and a controller 104. The controller 104 is coupled to the flash 102 for controlling operation of the flash 102. The flash 102 includes a read-only partition 1022 and a main storage partition 1024. The read-only partition 1022 stores an anti-virus application program, an anti-virus engine, and a virus pattern. Because a format of the read-only partition 1022 is a CD ROM format, contents of the read-only partition 1022 can not be changed after being manufactured. A user must first launch the anti-virus application program stored in the read-only partition 1022, and then the user can execute an access function on the main storage partition 1024. However, contents of the read-only partition 1022 of the flash 102 may be erased by an appropriate method, resulting in an anti-virus function of the anti-virus storage device 100 failing. In addition, after the flash 102 is operated for a period of time, the anti-virus application program often may not be executed due to bad blocks of the flash 102, also resulting in the anti-virus function of the anti-virus storage device 100 failing. And, when the user utilizes a Mac operating system or a Linux operating system, the user may not execute the access function on the main storage partition 1024 because the user can not first launch the anti-virus application program stored in the read-only partition 1022.

### SUMMARY OF THE INVENTION

An embodiment of the present application provides an operation method of an anti-virus storage device having a storage disk and a read-only memory. The method includes connecting the storage device to a host and displaying a single disk name on an interface of an operating system of the host, the single disk name represents the read-only memory at this stage; executing an anti-virus application program corresponding to the operating system, wherein the anti-virus application program is stored in the read-only memory; generating a hidden partition in the storage disk, wherein the hidden partition comprises an anti-virus engine and a virus pattern; and starting up the anti-virus engine, enabling a main storage partition. One thing should be noticed here that the single disk name displaying on the interface of the operating system, now represents the main storage partition at this stage.

The present application provides an anti-virus storage device using a read-only memory and method thereof. The anti-virus application program is stored in the read-only memory to avoid an anti-virus function of the anti-virus storage device failure due to bad blocks of the storage disk. And the anti-virus storage device only shows one disk at the same time, so a user is guided to first launch the anti-virus application program, and then the user can use the anti-virus storage device. Further, in the present application, the user can determine whether a main storage partition of the storage disk is enabled and displayed directly without executing the anti-virus application program when the anti-virus application program has no execution file corresponding to the operating system of the host.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an anti-virus storage device according to the prior art.

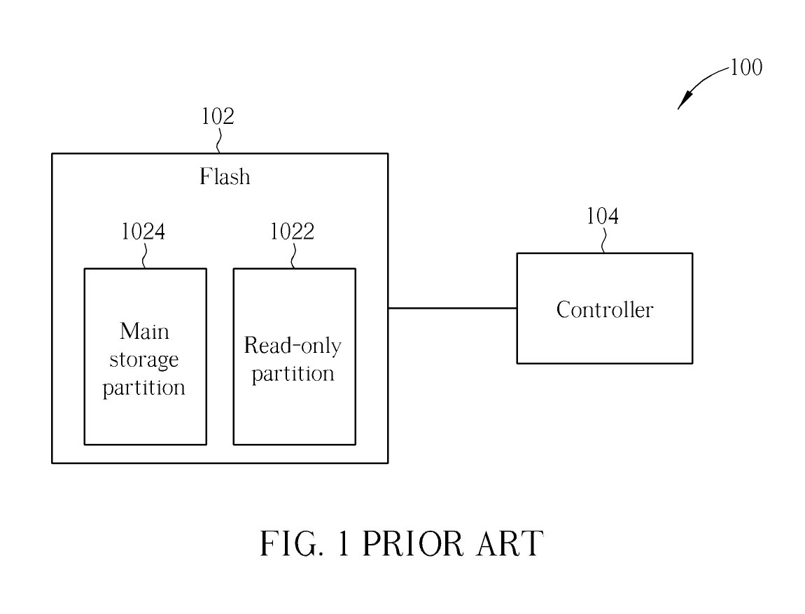

FIG. 2A is a diagram illustrating an anti-virus storage device using a read-only memory according to an embodiment of the present application.

FIG. 2B is a diagram illustrating an anti-virus storage device using a read-only memory according to another embodiment of the present application.

FIG. 2C is a diagram illustrating an anti-virus storage device using a read-only memory according to another embodiment of the present application.

FIG. 3 is a flowchart illustrating an anti-virus method using a read-only memory according to another embodiment of the present application.

### DETAILED DESCRIPTION

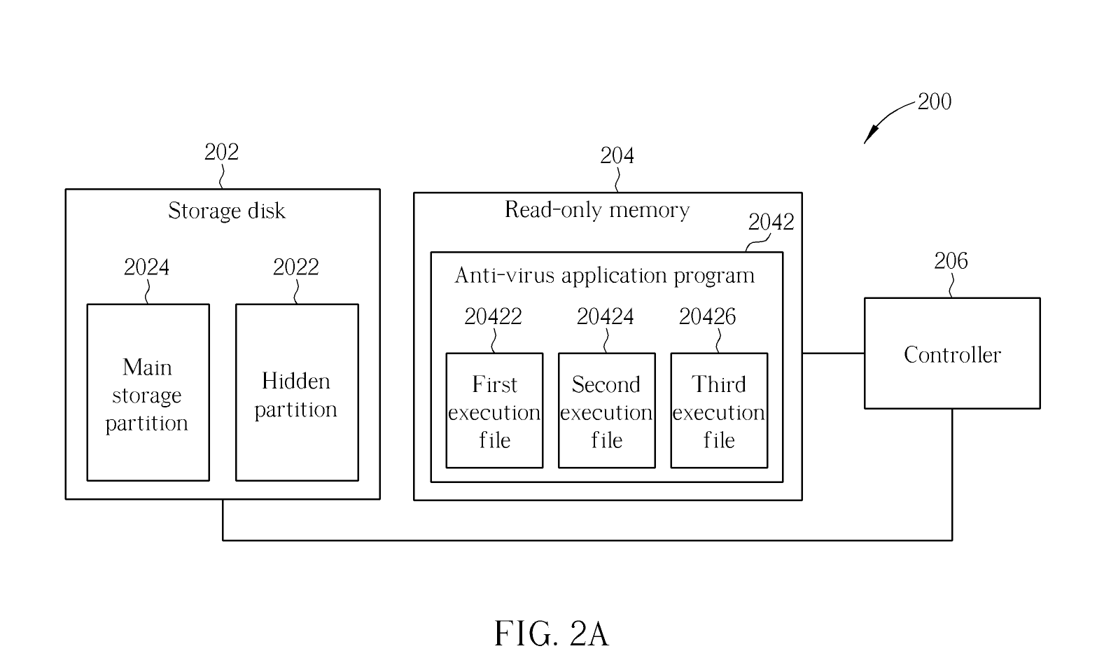

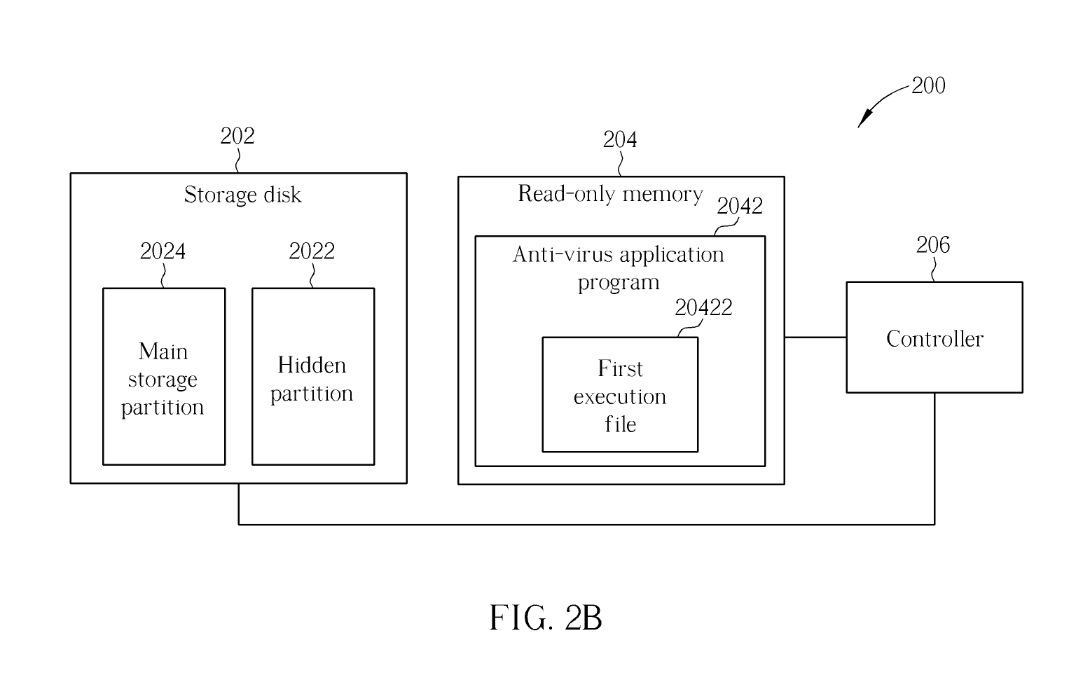

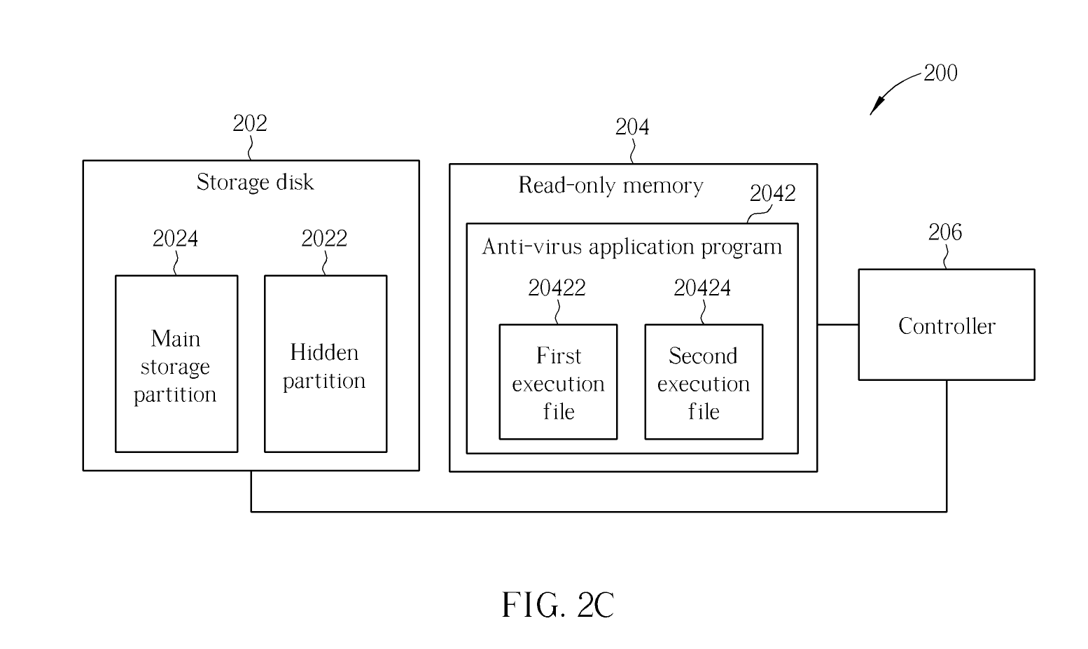

Please refer to FIG. 2A. FIG. 2A is a diagram illustrating an anti-virus storage device 200 using a read-only memory according to an embodiment of the present application. The anti-virus storage device 200 includes a storage disk 202, a read-only memory (ROM) 204, and a controller 206. The storage disk 202 is a flash, which includes a hidden partition 2022 and main storage partition 2024. The hidden partition 2022 is used for storing an anti-virus engine, a virus pattern and related programs, and the main storage partition 2024 is used for providing writing and reading of data for a user. The read-only memory 204 is used for storing an anti-virus application program 2042, and the anti-virus application program 2042 includes execution files for various operating systems. As shown in FIG. 2A, the anti-virus application program 2042 includes a first execution file 20422 executed in a first operating system (such as a WINDOWS operating system), a second execution file 20424 executed in a second operating system (such as a MAC operating system), and a third execution file 20426 executed in a third operating system (such as a LINUX operating system), where the read-only memory 204 includes, but is not limited to, an erasable programmable read only memory (EPROM), an electrically erasable programmable read only memory (EEPROM) or a programmable ROM (PROM). In addition, the read-only memory 204 can also utilize a flash set in a read-only mode. The controller 206 has I/O pins, which are coupled to the storage disk 202 and the read-only memory 204 for controlling operations of the storage disk 202 and the read-only memory 204. Further, the anti-virus storage device 200 is a Universal Serial Bus Flash Device (UFD), a Solid-State Drive (SSD) or other mass storage device.

When the user connects the anti-virus storage device 200 to a host, the user initially only sees a representative disk name of the read-only memory 204 on an interface of the operating system of the host. After the user launches/executes the anti-virus application program 2042 stored in the read-only memory 204, the user can execute the access function on the main storage partition 2024 of the storage disk 202. At this stage, it should be noticed that the interface of the operating system of the host still shows only one representative disk name, but a target disk corresponding to the representative disk name at this stage has been changed from the read-only memory 204 to the main storage partition 2024 of the storage disk 202, that is, the representative disk name represents the main storage partition at this stage. In addition, the anti-virus application program 2042 stored in the read-only memory 204 is similar to a shortcut file, so the user can copy the anti-virus application program 2042 to the host to execute installation and launch the anti-virus application program 2042.

Please refer to FIG. 2B and FIG. 2C. FIG. 2B is a diagram illustrating an anti-virus storage device 200 using a read-only memory according to another embodiment of the present application, and FIG. 2C is a diagram illustrating an anti-virus storage device 200 using a read-only memory according to another embodiment of the present application. A difference between the embodiment of FIG. 2B and the embodiment of FIG. 2A is that the anti-virus application program 2042 in FIG. 2B only includes the first execution file 20422 executed in the first operating system. Subsequent operational principles of the embodiment of FIG. 2B are the same as the embodiment of FIG. 2A, so further description thereof is omitted for simplicity. But, the embodiment of FIG. 2B is not limited to the first execution file 20422. The anti-virus application program 2042 can also include the second execution file 20424 executed in the second operating system or the third execution file 20426 executed in the third operating system. A difference between the embodiment of FIG. 2C and the embodiments of FIG. 2A and FIG. 2B is that the anti-virus application program 2042 in FIG. 2C includes the first execution file 20422 executed in the first operating system and the second execution file 20424 executed in the second operating system. Further, subsequent operational principles of the embodiment of FIG. 2C are the same as the embodiment of FIG. 2A, so further description thereof is omitted for simplicity. But the embodiment of FIG. 2C is not limited to the first execution file 20422 and the second execution file 20424. So, any anti-virus application program 2042 including the first execution file 20422, the second execution file 20424, the third execution file 20426, or a combination thereof falls within the scope of the present application.

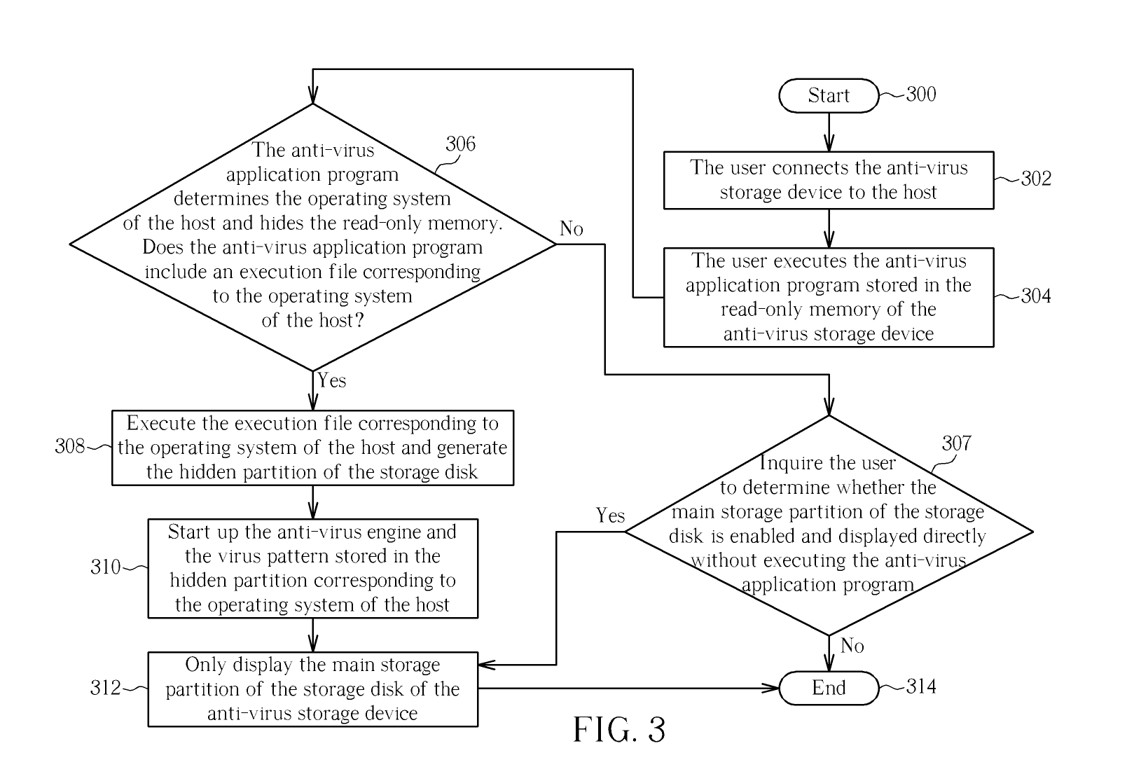

Please refer to FIG. 3. FIG. 3 is a flowchart illustrating an anti-virus method using a read-only memory according to another embodiment of the present application. The method in FIG. 3 is illustrated for the anti-virus storage device 200 in FIG. 2A. Detailed steps are as follows:

Step 300: Start.

Step 302: The user connects the anti-virus storage device 200 to the host.

Step 304: The user executes the anti-virus application program 2042 stored in the read-only memory 204 of the anti-virus storage device 200.

Step 306: The anti-virus application program 2042 determines the operating system of the host and hides the read-only memory 204. Does the anti-virus application program 2042 include an execution file corresponding to the operating system of the host? If yes, go to Step 308; if no, go to Step 307.

Step 307: Inquire the user to determine whether the main storage partition 2024 of the storage disk 202 is enabled and displayed directly without executing the anti-virus application program 2042. If yes, go to Step 312; if no, go to Step 314.

Step 308: Execute the execution file corresponding to the operating system of the host and generate the hidden partition 2022 of the storage disk 202.

Step 310: Start up the anti-virus engine and the virus pattern stored in the hidden partition 2022 corresponding to the operating system of the host.

Step 312: Only display the main storage partition 2024 of the storage disk 202 of the anti-virus storage device 200.

Step 314: End.

In Step 302, the anti-virus storage device 200 is a Universal Serial Bus Flash Device (UFD). In Step 304, the interface of the operating system of the host only shows the read-only memory 204 of the anti-virus storage device 200, so the user is guided to first execute the anti-virus application program 2042 stored in the read-only memory 204. In Step 306, the anti-virus application program 2042 determines the operating system of the host and hides the read-only memory 204. The anti-virus application program 2042 includes the first execution file 20422 executed in the first operating system, the second execution file 20424 executed in the second operating system, and/or the third execution file 20426 executed in the third operating system. If the anti-virus application program 2042 has no execution file corresponding to the operating system of the host, go to Step 307. In Step 307, the anti-virus storage device 200 inquires the user to determine whether the main storage partition 2024 of the storage disk 202 is enabled and displayed directly without executing the anti-virus application program 2042. If yes, go to Step 312; if no, go to Step 314. If the anti-virus application program 2042 has the execution file corresponding to the operating system of the host, go to Step 308. In Step 308, execute the execution file corresponding to the operating system of the host and generate the hidden partition 2022 of the storage disk 202, and go to Step 310. In Step 310, start up the anti-virus engine and the virus pattern stored in the hidden partition 2022 corresponding to the operating system of the host, and then go to Step 312.

To sum up, the present application provides the operation method of an anti-virus storage device having a storage disk and a read-only memory. In the present application, the anti-virus application program is stored in the read-only memory, and the read-only memory and the flash are configured independently to prevent failure of an anti-virus function of the anti-virus storage device due to bad blocks of the flash. And, the anti-virus storage device only shows one disk at the same time, so the user is guided to first launch the anti-virus application program, and then the user can execute the access function on the main storage partition of the storage disk. Further, operation of the prior art is limited to only one operating system. But, in the present application, the user can determine whether the main storage partition of the storage disk is enabled and displayed directly without executing the anti-virus application program when the anti-virus application program has no execution file corresponding to the operating system of the host.

Those skilled in the art will readily observe that numerous modifications and alterations of the device and method may be made while retaining the teachings of the application.

What is claimed is:

1. An operation method of an anti-virus storage device having a storage disk and a read-only memory, comprising:
connecting the storage device to a host and displaying a single disk name on an interface of an operating system of the host, wherein the single disk name represents the read-only memory;
executing an anti-virus application program corresponding to the operating system, wherein the anti-virus application program is stored in the read-only memory;
generating a hidden partition in the storage disk, wherein the hidden partition comprises an anti-virus engine and a virus pattern;
starting up the anti-virus engine, enabling a main storage partition of the storage disk, wherein a target disk corresponding to the single disk name is changed from the read-only memory to the main storage partition of the storage disk.

2. The operation method of claim 1, wherein the read-only memory comprises several application programs to respectively correspond to the different operating system of the host.

3. The operation method of claim 1, wherein after the step of connecting the storage device to a host further comprises: determining whether to enabling the main storage partition without executing the anti-virus application program.
